(19) United States
(12) Patent Application Publication
(10) Pub. No.: US 2012/0303331 A1
(43) Pub. Date: Nov. 29, 2012

(54) ADAPTER BETWEEN SCALE AND VITAL SIGNS MONITOR

(76) Inventors: Stephen Niemczak, Mokena, IL (US); Sanjay Mishra, North Potomac, MD (US)

(21) Appl. No.: 13/117,445

(22) Filed: May 27, 2011

(51) Int. Cl. G06F 15/00

(52) U.S. Cl. 702/198

(57) ABSTRACT

A method, an adapter and a system including a medical device and an adapter. The adapter receives patient scale data (e.g., height and weight data) from a scale. The patient scale data is in a first format data generally not interpretable by a vital sign monitoring device. The adapter translates the patient scale data into a second format compatible with the vital sign monitoring device. The adapter then outputs the translated data to the vital sign monitoring device. The scale and adapter may be coupled via a universal serial bus (USB) connection. The adapter and vital sign monitoring device may be coupled via one of a USB connection and an RS-232 connection. The patient data may be stored in an electronic health records (EHR) database by the vital sign monitoring device.

### BACKGROUND

The present invention relates to interfacing digital scales to external devices.

### SUMMARY

In one independent embodiment, a method for receiving, converting, and outputting at least one of weight and height data is provided. The method may generally include receiving, at an adapter host controller of an adapter, at least one of weight and height data from a scale device controller of a scale via a serial communications bus, the at least one of weight and height data being in a first data format. The method may further include converting, by the adapter, the at least one of weight and height data to a second data format, and outputting, by the adapter, the at least one of weight and height data in the second data format to a patient vital sign monitoring device.

In another independent embodiment, a scale-to-vital sign monitoring device adapter is provided. The adapter may generally include a serial communications input port, an adapter host controller, and a serial communications output port. The serial communications input port may receive at least one of weight and height data from a scale device controller of a scale via a serial communications bus, the at least one of weight and height data being in a first data format. The adapter host controller is coupled to the serial communications input port and includes a conversion module. The conversion module may convert the at least one of weight and height data to a second data format. The serial communications output port may output the at least one of weight and height data in the second data format to a patient vital sign monitoring device.

In some embodiments, the adapter may further include an adapter device controller for communicating with the vital sign monitoring device. In some embodiments, the scale and adapter may be coupled via a universal serial bus (USB) connection. Additionally, the adapter and vital sign monitoring device may be coupled via one of a USB connection and an RS-232 connection.

In yet another independent embodiment, a system for facilitating data communication is provided. The system may generally include a medical device operable to one of transmit patient data in a first data format and receive patient data in a second data format, the patient data indicating at least one of a weight and a height of the patient; and an adapter operable to communicate between the medical device and another device. The adapter may include an adapter host controller including a conversion module operable to convert the patient data from the first data format to the second data format, an adapter device controller operable to receive the converted patient data in the second data format from the adapter host controller, and a serial communications port coupled to one of the adapter host controller to receive the patient data from the first medical device in the first data format, and the adapter device controller to output the patient data to the first medical device in the second data format.

In some constructions, the medical device may include a scale operable to determine and transmit to the adapter patient data in the first data format. The other device may include a vital sign monitoring device operable to receive from the adapter patient data in the second format.

Other independent aspects of the invention will become apparent by consideration of the detailed description, claims, and accompanying drawings.

### BRIEF DESCRIPTION OF THE DRAWINGS

FIG. 1 illustrates a patient measurement and recordation system.

FIGS. 2-3 schematically illustrate an adapter coupled to a scale and a vital sign monitor, as shown in FIG. 1.

FIG. 4 illustrates the adapter shown in FIGS. 1-3 in greater detail.

FIG. 5 illustrates a conversion module of the adapter shown in FIGS. 2-3.

FIG. 6 illustrates a method of adapting a scale output to a vital sign monitor input.

FIG. 7 illustrates a method of adapting a vital sign monitor output to a scale input.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways.

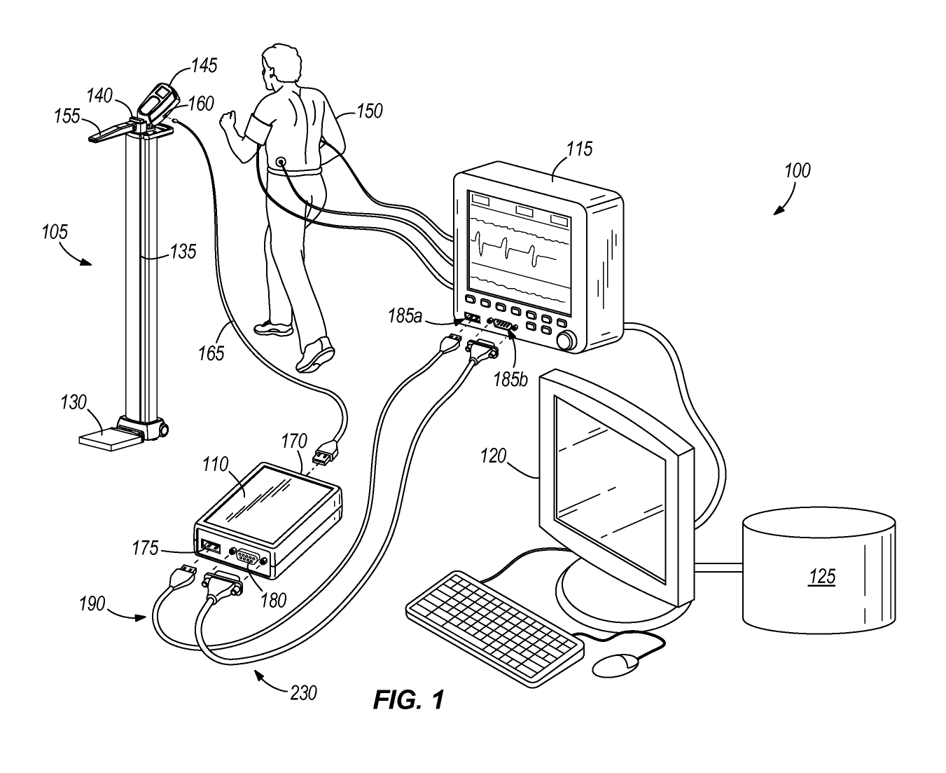

FIG. 1 depicts a patient measurement and recordation system 100 including a digital height and weight scale 105, an adapter 110, a vital sign monitoring device 115, a computer 120, and a electronic health records (EHR) database 125. In other constructions (not shown), the system 100 may include other components such as, for example, different measurement devices for measuring other health characteristics of a patient in addition to or in place of the scale 105.

The illustrated scale 105 generally includes a base 130, a pillar 135 with a telescoping height rod 140, and a display unit 145. The base 130 includes one or more weight sensors to measure the weight of an object, such as a patient 150, that is on the base 130. The measured weight is output as a digital signal to a controller (not shown) of the scale 105. The telescoping height rod 140 is movable up and down and includes an arm 155. The arm 155 is moved up or down to rest on top of an object (e.g., the patient 150) that is to have its height measured. Sensors within the pillar 135 output a digital signal indicating the height of the arm 155 based on tracking movement of the telescoping height rod 140. The digital weight signal and the digital height signal are received by the scale controller and output to the display unit 145 such that the patient and/or medical personnel can view the measured height and weight of the patient.

The display unit 145 also includes user input capability, such as a touch screen, a keyboard, etc. The patient 150 or medical personnel are able to enter information about the patient 150 to be associated with the measured height and weight. For instance, the name, date of birth, and/or gender of the patient 150 can be entered. The patient information, height, and weight received or determined by the scale 105 is collectively referred to as patient scale data. The patient scale data is stored locally on a memory of the controller.

The scale 105 may be similar to that shown and described in U.S. patent application Ser. No. 12/942,894, filed Nov. 9, 2010, the entire contents of which are hereby incorporated by reference.

In some constructions, the scale 105 does not include a digital height measurement capability. In these constructions, the height of the patient 150 may be entered via the display unit 145 in a manner similar to entering the other patient information. For example, the scale 105 may be similar to that shown and described in U.S. Pat. No. 7,550,682, issued Jun. 23, 2009, the entire contents of which are hereby incorporated by reference.

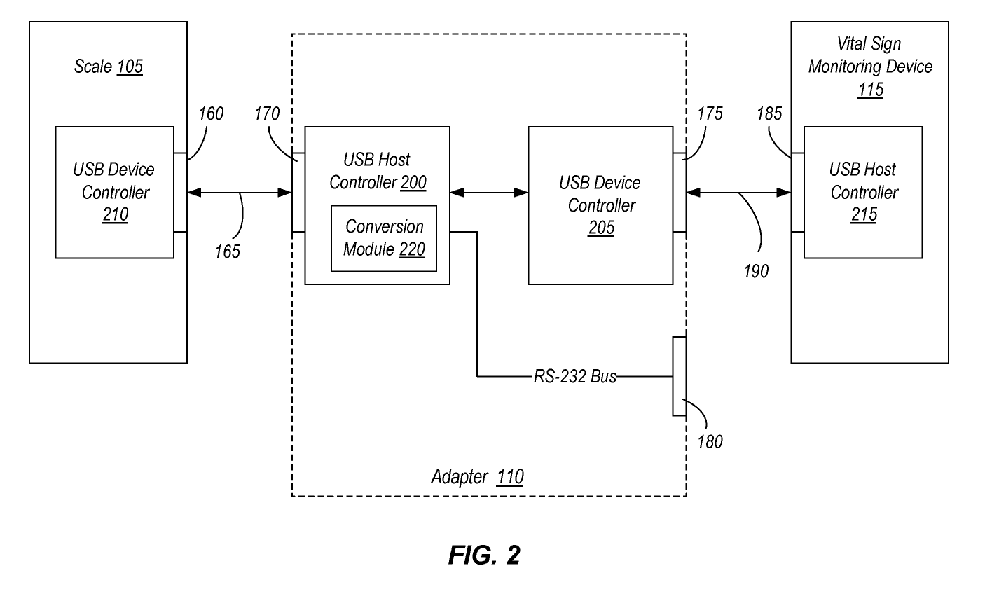

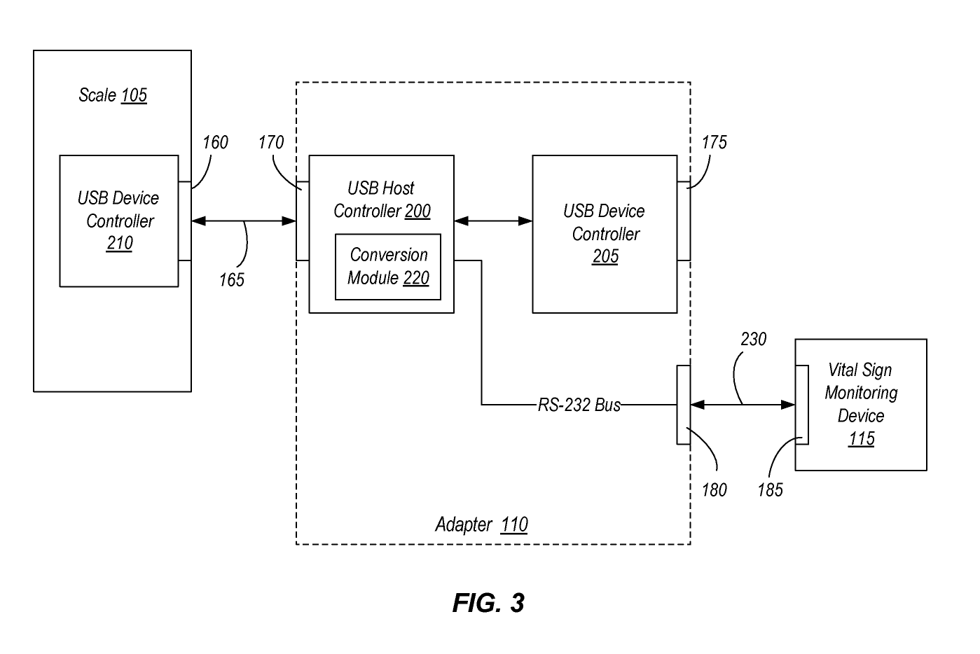

The scale 105 includes an output port 160 for outputting the patient scale data. The outputted patient scale data is used, for example, for remote viewing by medical personnel and for storage in the electronic health records (EHR) database 125. The scale 105 is coupled to the adapter 110 by way of a serial bus cable 165 coupled to the output port 160 and an input port 170 (see, e.g., FIGS. 2-3) of adapter 110.

The adapter 110 enables the scale 105 to communicate patient scale data to the vital sign monitoring device 115. The adapter 110 includes a Universal Serial Bus (USB) device port 175 and an RS-232 port 180 for outputting the patient scale data to the vital sign monitoring device 115. The vital sign monitoring device 115 includes an input port 185 for receiving a serial bus cable 190 coupled to the USB device port 175 or to the RS-232 output port 180.

The vital sign monitoring device 115 also monitors and stores vital signs data of the patient 150, such as heart rate, blood pressure, blood-oxygen levels, etc. The vital sign monitoring device 115 includes vital sign sensors for monitoring the vital signs of the patient 150. The vital sign monitoring device 115 includes user input capability, such as a touch screen, a keyboard, etc. The patient 150 and medical personnel are able to enter information about the patient 150 to be associated with vital signs data. For instance, the name, date of birth, and/or gender of the patient 150 can be entered. In some instances, the patient information is entered into one of the scale 105 and the vital sign monitoring device 115 and shared between the two. For instance, the vital sign monitoring device 115 receives the patient name, date of birth, and gender information from the scale 105 and a medical professional does not need to repeat the entering of the information about patient 150 into the vital sign monitoring device 115. The vital sign monitoring device 115 also includes a memory for storing the measured vital signs, patient information, and the patient scale data (collectively, “patient data”). In some instances, the memory of the vital sign monitoring device 115 is used for short-term, temporary storage of patient data before being output to the computer 120 or EHR 125.

The computer 120 is, for instance, a personal computer, laptop computer, tablet computer, or other device with the capability to forward patient data to the EHR 125 from a vital sign monitoring device 115. The computer 120 executes EHR software for communication with the EHR 125 to read patient data from and write patient data to the EHR 125. In some embodiments, the vital sign monitoring device 115 executes the software for communicating with the EHR 125 and the intermediary computer 120 is not used in the system 100. In some embodiments, a computer network, such as the Internet, a local area network (LAN), a wide area network (WAN), etc., or a wireless connection is used to connect the EHR 125 to the computer 120 or the vital sign monitoring device 115.

FIG. 2 illustrates the adapter 110 and the connections between the adapter 110 and the scale 105 and the vital sign monitoring device 115 in greater detail. The output port 160 of scale 105 is a USB device port, the input port 170 of the adapter 110 is a USB host port, and the serial bus cable 165 is a USB cable. The output port 175 of adapter 110 is a USB device port, the input port 185 of the vital sign monitoring device 115 is a USB host port, and a serial bus cable 190 is a USB cable that couples the adapter 110 and the vital sign monitoring device 115.

The adapter 110 includes a USB host controller 200 (i.e., an adapter host controller) and a USB device controller 205 (i.e., an adapter device controller). The scale 105 includes a USB device controller 210 and the vital sign monitoring device 115 includes a USB host controller 215. According to the USB standard (e.g., Universal Serial Bus Specification Revision 2.0, published Apr. 27, 2000), USB communications occur between a USB host and a USB device. In FIG. 2, the USB device controller 210 of the scale 105 is a USB device and the USB host controller 200 of the adapter 110 is a USB host according to the USB standard. Similarly, the USB device controller 205 of the adapter 110 is a USB device and the USB host controller 215 of the vital sign monitoring device 115 is a USB host according to the USB standard. For instance, the USB Host controller 200 and USB device controller 205 are each 8-bit AVR Microcontrollers with an integrated USB controller, such as the AVR model AT90USB1287.

The USB host controller 200 of the adapter 110 includes a conversion module 220 that receives patient scale data in a first data format from the USB device controller 210 of the scale 105. The conversion module 220 converts the patient scale data from the first scale data format to an appropriate second format for the vital sign monitoring device 115. For instance, the first format may represent patient scale data differently than the second format, such as by using a different order, numbers of bits, encoding, unit of measurement, etc. Without the conversion by the adapter 110, the vital sign monitoring device 115 will generally not be able to interpret the patient scale data output by the scale 105.

Once converted to the format of the vital sign monitoring device 115, the patient scale data is output from the USB host controller 200 to the USB device controller 205. The USB device controller 205 then outputs the converted patient scale data to the USB host controller 215 of the vital sign monitoring device 115 via the USB cable 190.

FIG. 3 depicts the system 100 in which the vital sign monitoring device 115 is coupled to the adapter 110 via an RS-232 cable 230 rather than the USB cable 190. In FIG. 3, the vital sign monitoring device input port 185 is an RS-232 port. In some embodiments, the vital sign monitoring device 115 includes both an RS-232 port and a USB port and either one may be coupled to the adapter 110. When the adapter 110 is coupled to the vital sign monitoring device 115 using the RS-232 cable 230, the USB host controller 200 outputs the patient scale data converted by conversion module 220 along the RS-232 bus rather than first passing the patient scale data to the USB device controller 205. In some embodiments, however, the patient scale data is first sent to the USB device controller 205, which forwards the data to the vital sign monitoring device 115 via an RS-232 connection.

In some embodiments, the conversion module 220 is positioned outside the USB host controller 200, such as within the USB device controller 205 or as an independent module of the adapter 110. In these embodiments, the patient scale data is received by the USB host controller 200, sent to conversion module 220, converted, and sent to the USB device controller 205 for output to the vital sign monitoring device 115 via the USB device port 175 or the RS-232 port 180.

The vital sign monitoring device 115 provides power to the adapter 110 via the USB device port 175 when coupled by USB cable 190 (FIG. 2) and via RS-232 port 180 when coupled via RS-232 cable 230 (FIG. 3). In turn, the adapter 110, via USB host controller 200, provides power to the scale 105 via serial bus cable 165. In some embodiments, when the adapter 110 receives power via the RS-232 port 180, the USB device controller 205 is not powered.

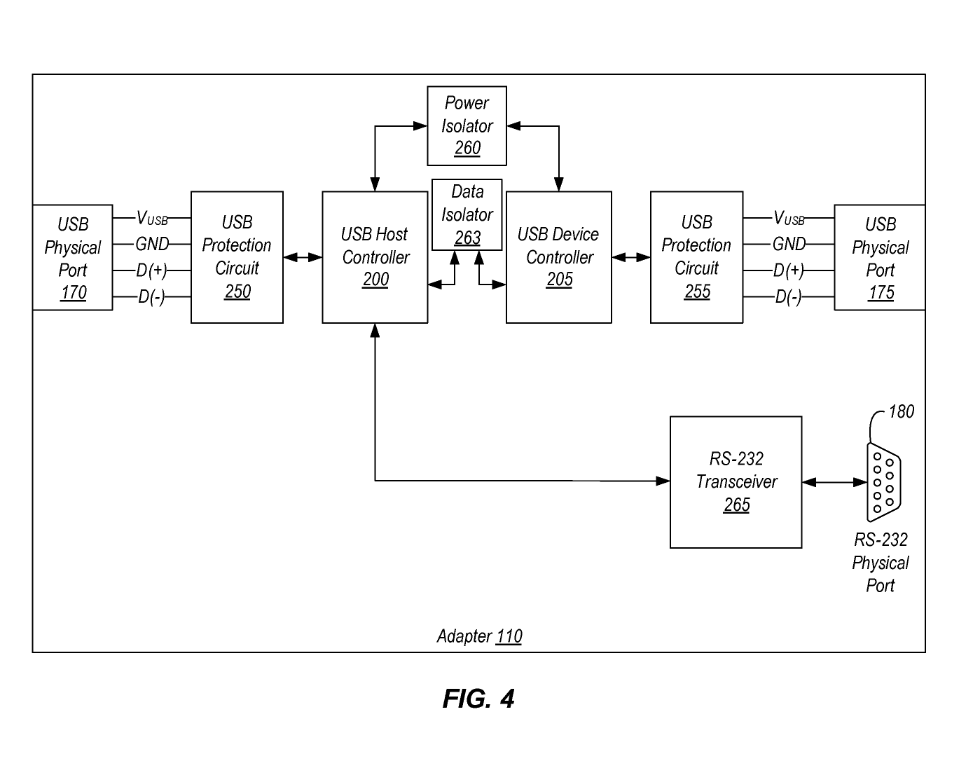

FIG. 4 depicts the adapter 110 in greater detail. The adapter 110 includes USB protection circuits 250 and 255 coupled to the USB host port 170 and the USB device port 175, respectively. The adapter 110 also includes a power isolator 260, a data isolator 263, and an RS-232 transceiver 265. The USB protection circuits 250 and 255 provide data line protection for the adapter 110 to protect the circuitry therein. For instance, the USB protection circuits 250 and 255 protect the two data lines (D+ and D−) against overvoltage damage caused by fast transient signals and electrostatic discharge. The USB protection circuits 250 and 255 are each, for instance, a USB6B1 chip.

The power isolator 260 isolates the USB host controller 200 from the USB device controller 205. This power isolator 260 prevents damage to the vital sign monitoring device 115 that may be caused by a malfunction in the via the USB device port 175, and the power isolator 260 provides isolated power to the USB host controller 200. In some embodiments, the power isolator 260 includes a transformer, such as an EPC3126 transformer provided by PCA Electronics, Inc., which isolates power supplies between the USB host controller 200 and the USB device controller 205. Additionally, the transformer may be driven by a primary-side transformer driver, such as an MAX253 driver provided by Maxim Integrated products, and the output may be regulated by a voltage regulator, such as an LT1963 regulator provided by Linear Technology.

The data isolator 263 isolates data communications between the USB host controller 200 and the USB device controller 205, protecting each controller from damage that may be caused by the other controller. In some embodiments, the data isolator 263 is a quad channel digital isolator, such as an ADuM2401 or ADuM6400 isolator provided by Analog Devices, Inc.

The RS-232 transceiver 265 receives data from the USB host controller 200 to be output to the vital sign monitoring device 115 via the RS-232 port 180. The RS-232 transceiver 265 ensures that the data signals received from the USB host controller 200 are converted to abide by RS-232 communication standards. The RS-232 transceiver 265 also receives data from vital sign monitoring device 115 and converts the data to an appropriate level for input to the USB host controller 200. In some embodiments, the RS-232 transceiver 265 is a MAX3232 chip provided by Maxim Integrated Products.

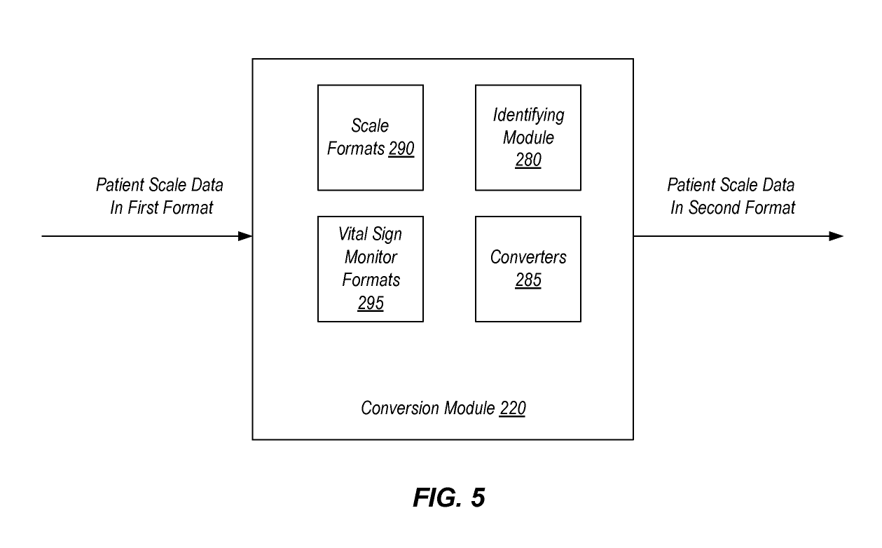

FIG. 5 depicts the conversion module 220 in greater detail. The conversion module 220 includes an identifying module 280 and converters 285. The identifying module 280 determines the data format being used by the scale 105 and the data format being used by the vital sign monitoring device 115. In some instances, the identifying module 280 first determines the model type of the scale 105 and of the vital sign monitoring device 115 and uses the model types as indexes into a scale formats database 290 and vital sign monitor formats database 295, respectively, to determine the format used by each. In other instances, the scale 105 and the vital sign monitoring device 115 provide the format type to the identifying module 280. Regardless of the method of determining the format types, the identifying module 280 selects the appropriate converter from converters 285 based on the determined format types. For example, the converters 285 may be a database of converters, and the identifying module 280 may use the format types as an index to select the appropriate converter. In other examples, the format types are provided to the converters 285, which include logic to identify the appropriate converter for use in converting data from the scale data format to the vital sign monitoring device data format.

The converters 285 include one or more converters, each capable of translating data input in a first format into data output in a second format. The appropriate converter within converters 285 is selected based on the identified formats of the scale 105 and the vital sign monitoring device 115. The converters and the identifying module include, for instance, software and/or circuits used to execute the software (e.g., a processor of the USB host controller 200). In other embodiments, the converters 285 and the identifying module 280 are independent of the USB host controller 200 and are formed using an application specific integrated circuit (ASIC), a field programmable gate array (FPGA), a microcontroller, or another device.

The conversion module 220 is reconfigurable to adapt to various scales, vital sign monitoring devices, and data formats used by each. For instance, the converters 285, the identifying module 280, the scale formats database 290, and the vital sign monitor formats 295 may all be updated by providing a software update to the USB host controller 200. For example, if a new scale with a new data format is released in the market or if a scale has not yet been loaded into the adapter 110, the identifying module 280 is updated to identify the “new” scale type, the scale format database 290 is updated to associate the “new” scale format to the new scale type, and the converters 285 are updated to include new converters to accommodate the new format type. Accommodating the new format type includes enabling conversion from the new format type to the one or more of the various vital sign monitor formats (and vice versa). A “new” scale type and “new” scale format do not necessarily mean that the scale or format did not previously exist but, rather, may also include preexisting scale types and scale formats not previously loaded into the adapter 110.

Similarly, if a new vital signs monitoring device with a new data format is released in the market or if a vital signs monitoring device has not yet been loaded into the adapter 110, the identifying module 280 is updated to identify the “new” vital signs monitoring device type, the vital signs monitoring device format database 290 is updated to associate the “new” vital signs monitoring device format to the new vital signs monitoring device type, and the converters 285 are updated to include new converters to accommodate the new format type. Accommodating the new format type includes enabling conversion from the various scale formats to the new vital sign monitor format (and vice versa). A “new” vital signs monitoring device type and “new” vital signs monitoring device format do not necessarily mean that the vital signs monitoring device or format did not previously exist but, rather, may also include preexisting vital signs monitoring device types and formats not previously loaded into the adapter 110.

In some embodiments, the update of the conversion module 220 occurs through one of the input port 170, the output port 175, and the output port 180 by coupling an updating device (e.g., a laptop) to the adapter 110 by way of one of these ports. In other embodiments, another port (not shown) is used for updating is employed.

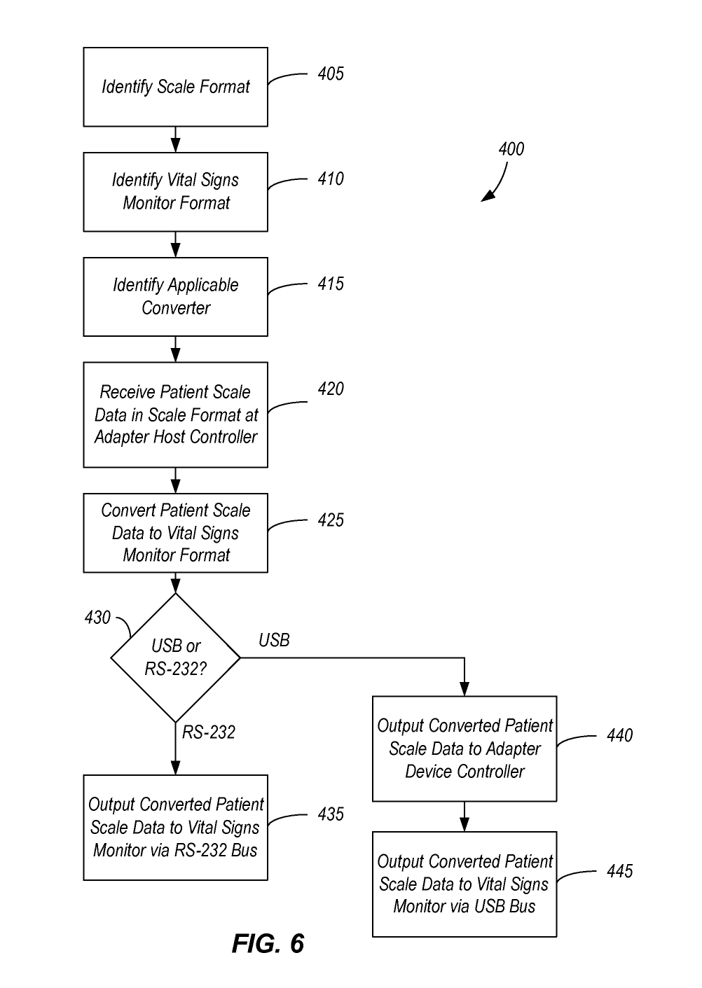

FIG. 6 depicts a method 400 for adapting a scale output to a vital sign monitor input. Although the method 400 is described with respect to the scale 105, the adapter 110, and the vital sign monitoring device 115, the method 400 is usable with other devices as well. After the scale 105 is coupled to the adapter 110, e.g., via serial bus cable 165, the identifying module 280 identifies the data format of the scale 105 as a first format (step 405). After the vital sign monitoring device 115 is coupled to the adapter 110, e.g., via USB cable 190 or RS-232 cable 230, the identifying module 280 identifies the data format of the vital sign monitoring device 115 as a second format (step 410). In some embodiments, the steps of identifying 405 and 410 are executed simultaneously or in reverse order from that shown in FIG. 6.

In step 415, the conversion module 220 identifies the appropriate converter within converters 285 to use to translate data received from the scale 105 that is to be output to the vital sign monitoring device 115. In step 420, the conversion module 220 receives patient scale data from scale 105 in the first format. In some embodiments, one or more of the identifying steps 405, 410, and 415 are performed after receiving the patient scale data (step 420). In step 425, the identified converter within the converters 285 converts the patient scale data to the second format.

In step 430, the USB host controller 200 determines whether the vital sign monitoring device 115 is coupled to the adapter 110 via a USB cable 190 (see FIG. 2) or RS-232 cable 230 (see FIG. 3). If the RS-232 cable 230 is being used, the USB host controller 200 proceeds to output the converted patient scale data in the second format along the RS-232 cable 230 to the vital sign monitoring device 115 (step 435).

If USB cable 190 is being used, the USB host controller 200 proceeds to output the converted patient scale data in the second format to the USB device controller 205 (step 440). The USB device controller 205 then proceeds to output the converted patient scale data along the USB cable 190 to the vital sign monitoring device 115 (step 445). Thereafter, as described above, the vital sign monitoring device 115 performs one or more of the following actions: storing the patient scale data locally, associating the patient scale data with patient vital sign data, displaying the patient scale data, and outputting the patient scale data to the EHR 125 or computer 120.

In some embodiments, the determination step 430 is not performed. Rather, the USB host controller 200 outputs the converted patient scale data in the second format along both the RS-232 cable 230 and the USB cable 190 without making the determination of step 430. However, as the USB device controller 205 is powered by the USB host controller 215, if the vital sign monitoring device 115 is not coupled to the adapter 110 via the USB device port 175, the USB device controller 205 is not powered to output the converted patient scale data from the USB host controller 200. Thus, although the USB host controller 215 may output the converted patient scale data to the USB device controller 205, the USB device controller 205 would not have power and, thus, would not be able to receive or output the converted patient scale data.

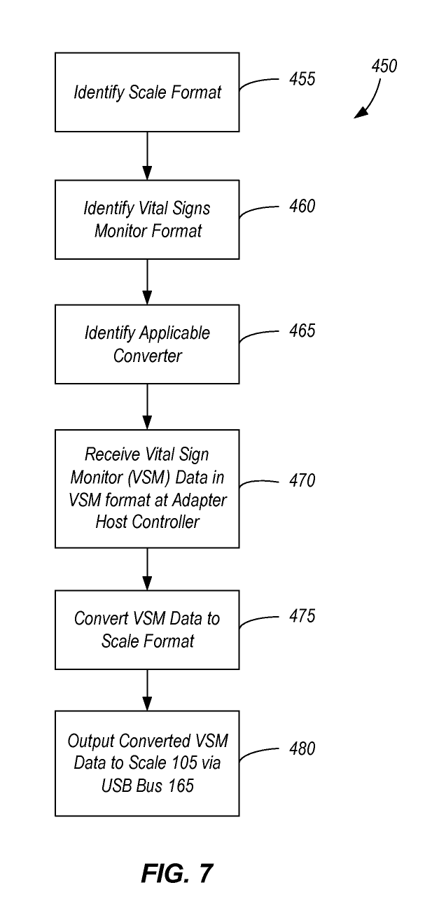

The adapter 110 may also be able to facilitate communication from the vital sign monitoring device 115 to the scale 105. For instance, the adapter 110 receives data from the vital sign monitoring device 115 and converts the data to a format of the scale 105 using conversion module 220. The method 450 of FIG. 7 is for adapting a vital sign monitor output to a scale input, which includes steps similar to steps 405-425 of method 400 in FIG. 6. In steps 455 and 460, the format of scale 105 and format of vital sign monitoring device 115 are identified by the identifying module 280. In step 465, the applicable converter within converters 285 for converting data from the format of the vital sign monitoring device 115 to the format of the scale 105 is identified. In step 470, vital sign monitoring data is received from the vital sign monitoring device 115 and, in step 475, the vital sign monitoring data is converted to the scale format. In step 480, the converted data is output to the scale 105 in the scale data format. Data sent from the vital sign monitoring device 115 may include, for instance, patient vital signs information for display or storage on the scale 105, other patient information, commands for the scale 105, etc.

Additionally, the adapter 110 may also facilitate communication between the vital sign monitoring device 115 coupled to one of the USB device port 175 and the RS-232 output port 180 and another device coupled to the other of USB device port 175 and the RS-232 output port 180. The other device may be another vital sign monitoring device or other medical equipment. For instance, the USB host controller 200 is operable to receive the output of the vital sign monitoring device 115 via the USB device port 175, convert the data as necessary, and output the converted data via the RS-232 output port 180 to the other device. Communications may similarly flow in the opposite direction. Furthermore, the vital sign monitoring device 115 may be connected to the RS-232 output port 180 and the other device may be connected to the USB device port 175.

Although described in the medical field context with measuring characteristics of a patient, the scale 105 and the adapter 110 are also operable for use with measuring other objects. Furthermore, although the scale 105, the adapter 110, and the vital sign monitoring device 115 are described as using USB or RS-232 communications, in some embodiments, other communication techniques are used.

Thus, the invention may generally provide, among other things, a system and method for measuring patient characteristics, transmitting the measurements, and recording the measurements using a reconfigurable adapter positioned between a measuring device or scale and a vital sign monitoring device. The reconfigurable nature of the adapter may enable post-manufacture and post-sale updates to modify the adapter to enable communications among new scales, new vital sign monitors (or other devices for receiving scale output), and devices using new or previously unused data protocols. Various independent features and independent advantages of the invention are set forth in the following claims.

What is claimed is:

1. A method comprising:
receiving, at an adapter host controller of an adapter, at least one of weight and height data from a scale device controller of a scale via a serial communications bus, the at least one of weight and height data being in a first data format;
converting, by the adapter, the at least one of weight and height data to a second data format; and
outputting, by the adapter, the at least one of weight and height data in the second data format to a patient vital sign monitoring device.

2. The method of claim 1, further comprising outputting, by the patient vital sign monitoring device, the at least one of weight and height data to an electronic health records database.

3. The method of claim 1, wherein the serial communications bus is a universal serial bus (USB).

4. The method of claim 1, wherein the step of outputting, by the adapter, includes transmitting the at least one of weight and height data in the second data format via one of a universal serial bus (USB) connection and an RS-232 connection.

5. The method of claim 1, wherein the step of outputting, by the adapter, includes
transmitting, by the adapter host controller, the at least one of weight and height data in one of the first data format and the second data format to an adapter device controller of the adapter, and
transmitting, by the adapter device controller, the at least one of weight and height data in the second data format to the patient vital sign monitoring device via a second serial communications bus.

6. The method of claim 5, wherein the step of transmitting, by the adapter host controller to the adapter device controller, includes communicating the at least one of weight and height data to an isolating communications device.

7. The method of claim 1, wherein the step of outputting, by the adapter, includes transmitting, by the adapter host controller, the at least one of weight and height data in the second data format to the patient vital sign monitoring device via an RS-232 bus.

8. The method of claim 1, wherein the step of converting, by the adapter, includes
identifying the patient vital sign monitoring device, and
selecting the second data format as a conversion output format based on the identification.

9. The method of claim 1, wherein the step of converting, by the adapter, includes
identifying the first data format,
identifying the second data format,
selecting a converter for converting data from the first data format to the second data format, and
employing the converter to perform the step of converting, by the adapter, the at least one of weight and height data to the second data format.

10. An adapter comprising:
a serial communications input port that receives at least one of weight and height data from a scale device controller of a scale via a serial communications bus, the at least one of weight and height data being in a first data format;
an adapter host controller coupled to the serial communications input port and including a conversion module that converts the at least one of weight and height data to a second data format; and
a serial communications output port that outputs the at least one of weight and height data in the second data format to a patient vital sign monitoring device.

11. The adapter of claim 10, wherein the serial communications bus is a universal serial bus (USB).

12. The adapter of claim 10, wherein the serial communications output port is one of a universal serial bus (USB) port and an RS-232 port.

13. The adapter of claim 10, further comprising an adapter device controller coupled to the adapter host controller, the adapter device controller receiving the at least one of weight and height data in the second data format from the adapter host controller and outputting the at least one of weight and height data in the second data format to the patient vital sign monitoring device via the serial communications output port.

14. The adapter of claim 13, further comprising an isolator coupled between the adapter host controller and the adapter device controller, the isolator providing an isolated communications path between the adapter host controller and the adapter device controller.

15. The adapter of claim 10, wherein the serial communications output port is an RS-232 port coupled to an output of the adapter host controller, and wherein the adapter host controller outputs the at least one of weight and height data in the second data format to the RS-232 port.

16. The adapter of claim 10, wherein the adapter host controller includes
a plurality of converters for translating data to a plurality of formats, and
an identifying module that identifies the first data format, identifies the second data format, and selects a converter that converts data from the first data format to the second data format.

17. The adapter of claim 16, wherein the identifying module identifies the first data format and the second data format by identifying the scale and identifying the patient vital sign monitoring device and associating the scale with the first data format and associating the patient vital sign monitoring device with the second data format.

18. A system for facilitating data communication, the system comprising:
a medical device operable to one of transmit patient data in a first data format and receive patient data in a second data format, the patient data indicating at least one of a weight and a height of the patient; and
an adapter operable to communicate between the medical device and another device, the adapter including
an adapter host controller including a conversion module operable to convert the patient data from the first data format to the second data format,
an adapter device controller operable to receive the converted patient data in the second data format from the adapter host controller, and
a serial communications port coupled to one of
the adapter host controller to receive the patient data from the medical device in the first data format, and
the adapter device controller to output the patient data to the medical device in the second data format.

19. The system of claim 18, wherein the medical device includes a scale operable to determine and transmit to the adapter patient data in the first data format.

20. The system of claim 19, wherein the other device includes a vital sign monitoring device operable to receive from the adapter patient data in the second data format.
